(19) United States
(12) Patent Application Publication
(10) Pub. No.: US 2019/0387855 A1
(43) Pub. Date: Dec. 26, 2019

(54) WATERPROOF, BREATHABLE BAG WITH NO INTERIOR CONDENSATION

(71) Applicant: MAT PRODUCT & TECHNOLOGY, SLU, Barcelona (ES)

(72) Inventors: Xavier Mateu Codina, Barcelona (ES); Colin Ramsay Bell, Barcelona (ES)

(73) Assignee: MAT PRODUCT & TECHNOLOGY, SLU, Barcelona (ES)

(21) Appl. No.: 16/448,957

(22) Filed: Jun. 21, 2019

(30) Foreign Application Priority Data
Jun. 21, 2018 (ES) 201830960

(51) Int. Cl. A45C 13/00; A45F 3/04; B32B 7/02; G05D 22/02

(52) U.S. Cl. CPC A45C 13/008; A45F 3/04; B32B 2307/724; G05D 22/02; B32B 7/02

(57) ABSTRACT

A waterproof, breathable bag that defines an interior space completely surrounded by waterproof material, at least part of said waterproof material also being a breathable multi-layered material that includes a layer of waterproof, breathable material to prevent the passage of water and to allow the passage of air therethrough; wherein the waterproof, breathable bag includes in its interior a heating device that includes a heating resistor in thermal contact with the inside air of the bag, a battery also housed in said bag and connected to a heating resistor and a controller device.

### FIELD OF THE ART

The present invention relates to a waterproof, breathable bag with no interior condensation, said bag including a breathable, waterproof multi-layered material in at least part of the bag that allows the passage of air and vapour from the inside to the outside, but which prevents the passage of water from outside to the inside, said bag being a rucksack, a wallet, a briefcase, a suitcase, a bag, a kit bag, or any other similar leather goods.

The bag also includes in its interior a heating device formed by a heating resistor connected to a battery to increase the inside temperature of the bag, thereby preventing, in conditions of high humidity and variations of the temperature outside of the bag, condensation from being produced therein.

### STATE OF THE ART

The use of breathable, waterproof multi-layered materials is known for the manufacturing of bags.

This type of bag prevents the inflow of outside water, rainwater for example, within the bag, while allowing the transpiration of a possible source of humidity contained inside the bag, such as, for instance, the case in which humid elements or humid clothes are placed inside said bag.

However, in conditions of a fast temperature drop of the inside air of the bag, for example when removing the bag from a heated indoor environment to a cold outdoor environment, said fast temperature drop may produce the condensation of the inside humidity of the bag before it has been possible to remove said humidity from the bag by means of transpiration.

This phenomenon occurs more frequently in the case of storing electronic devices within said bag, since the electronic devices that have frequently been used in a heated indoor environment are stored in the bag still warm as a result of their use, and the bag is immediately taken to a cold outdoor environment, said condensation occurring on the electronic devices, favouring their oxidization.

It is known that a breathable, waterproof multi-layered material may include a perforated or micro-perforated leather layer to improve its breathability, typically leather provided with a protective surface treatment, but in such a case the water may go through the holes, whereby the leather loses its waterproofing properties. In order to regain the waterproofing properties of the perforated leather, in the shoe industry, the application of a layer of waterproof, breathable material is known.

For example, ES2142620T3 describes a shoe provided with a breathable, waterproof sole consisting of a perforated sole, a waterproof, breathable layer and an insole which is suggested to be of a breathable material or that is perforated, leather being cited as an option.

EP0619959A1 also describes a breathable, waterproof shoe sole very similar to the above.

In these two known solutions, the leather layer can absorb water, which produces its swelling, strain and the appearance of undesirable odours, both when using full grain leather, which is absorbent, and using leather provided with a protective surface treatment, since the holes or micro-holes go through that protective coating and leave the exposed leather uncoated on the inside walls of the ducts formed by said holes or micro-holes.

Furthermore, the creation of holes or micro-holes in an absorbent material such as leather causes said water droplets, when they settle on its surface, to be absorbed towards the interior of the holes or micro-holes by capillary action.

### BRIEF DESCRIPTION OF THE INVENTION

The present invention relates to a waterproof, breathable bag with no interior condensation that defines an interior space completely surrounded by waterproof material, at least part of said waterproof material also being a breathable, multi-layered material that includes a layer of waterproof, breathable material to prevent the passage of water and to allow the passage of air therethrough.

That is, the interior of the bag is completely surrounded by waterproof material, but all or part of said waterproof material is also a breathable, waterproof multi-layered material.

The layer of waterproof, breathable material is a layer that prevents the passage of liquid water therethrough but which allows the passage of air and water vapour therethrough. This may be achieved, for example, by means of a layer provided with pores whose size is of the order of thousands of times smaller than the size of the water droplets, but which is of the order of hundreds of times larger than the size of the water vapour molecules.

Preferably, the water vapour permeability of the layer of waterproof, breathable material will be equal to or greater than 475 g/cm², said values being liable to be measured, for example, through the guidelines of standard BS 7209:1990 in effect on the date the present application was filed.

It is also contemplated that said waterproof material layer have a resistance to the passage of water equal to or greater than 10 psi during at least 2 minutes, said values being liable be measured, for example, through the guidelines of standard ISO 811:2018 in effect on the date the present application was filed.

The present invention also proposes, in a way unknown in the existing state of the art, that the waterproof, breathable bag include in its interior a heating device that includes a heating resistor in thermal contact with the inside air of the bag, a battery also housed in said bag and connected to the heating resistor and a controller device that allows connecting or disconnecting the heating resistor to the battery to control its activation and deactivation.

The heating resistor, powered by the battery, allows to increase the temperature of the inside air of the bag, thereby achieving its cooling and, therefore, avoiding the condensation of the humidity contained therein.

The cooling of the inside air may be produced if the bag goes from a relatively warm environment, such as a heated indoor space, to a cold outdoor space.

The cold air may contain less quantity of water vapour than warm air, whereby in case the air has a high percentage of humidity, its cooling may cause said percentage to be increased until reaching 100%, thereby producing condensation.

The proposed heating device prevents this phenomenon from occurring, protecting the contents of the bag from said condensation, achieving an inside air with a low percentage of humidity, which is especially important if electronic equipment such as tablets or computers, for instance, are stored inside the bag.

The heating resistor will be, for example, a flexible semiconductor, that allows it to adapt to the movement of the material that constitutes the bag.

According to an additional embodiment of the waterproof, breathable bag, the battery may be housed in a pocket of the bag, and will preferably be connected to the heating resistor by means of a movable connector, allowing for a fast, simple removal and/or replacement of the battery, the heating resistor remaining attached to the bag.

The controller device may either be embedded in the battery, thus being removed from the bag along with said battery, or be embedded in the bag along with the heating resistor, only the battery being movable.

The movable connector will be a standard connector, of complementary plug and socket types, that will allow for a fast and safe connection, as well as its release, thus allowing the removal of the battery for its replacement or charging in a simple, fast and safe manner.

According to the preferred embodiment, the heating resistor is attached to the waterproof material, ideally to the breathable, waterproof multi-layered material, embedding it, for example, between the layers of the breathable multi-layered material.

The heating resistor may be attached to the rest of the bag by means of sewing, without hindering its operation.

Additionally, it is proposed that the controller device include a temperature sensor, and that it be configured to turn on the heating resistor in response to the readings obtained by the temperature sensor. This way, the bag may succeed in automatically turning on the heating resistor when certain temperature conditions are met that are considered to favour the appearance of condensation therein, following the programming embedded in the controller device.

The controller device may additionally or alternatively include a wireless communication device configured to connect to a remote-control device, for example a smart phone, a smart watch, a tablet or a computer.

The wireless communication device may be, for example, a WIFI antenna and/or a BLUETOOTH antenna. When connecting to a remote-control device, such as those previously mentioned, said remote-control devices may allow the user to turn on or off the heating resistor of the bag remotely, may include temperature sensors, may access weather data—such as, for instance, the percentage of ambient humidity—through the Internet, and/or may be programmed to turn the heating resistor on or off in response to certain parameters, such as, for example, said weather data, or the readings from the sensors embedded in the remote-control device.

This also allows other features, such as turning the heating resistor off if the remote-control device moves away from the bag, or outputting a warning signal if said separation occurs, in addition to allowing to control the temperature level of the heating resistor or the battery charge level through said remote-control device.

Regardless of the above, the heating device may include a signal emitter selected from luminous and/or acoustic signals to inform of the activation and/or the temperature of the heating resistor and/or the state of the battery charge.

It is also proposed that the battery include a connection cable configured to supply power to an additional electronic device, that is, to power an electronic device that does not include the heating device, for example a smart mobile phone, the bag battery thus acting as a backup battery for said additional electronic devices.

Said connection cable may be accessible from outside of the bag through an outer pocket, thus facilitating that an additional electronic device stored in said outer pocket may be charged, or, if part of the connection cable is removed from the pocket, allowing the operation of the additional electronic device while its battery is being charged.

Preferably, the battery will be a 12V battery.

According to another proposed embodiment, the breathable, waterproof multi-layered material also includes a natural leather or collagen leather layer, this leather layer including holes and/or micro-holes to increase its breathability, the leather layer being in the extrados of the bag and the layer of waterproof, breathable material in the intrados of the bag.

It will be understood that natural leather is the leather obtained from the curing of animal hide, and that collagen leather is a product with properties and an appearance equal or similar to those of natural leather obtained from the processing of collagen of animal origin or of a different origin.

For example, collagen leather may be produced from collagen obtained from the recycling of natural leather, or from collagen produced by cultures of cells that have been genetically modified to produce collagen.

When the leather is lacking protective surface treatments, it is known as full grain leather. Full grain leather is partially breathable and also presents high water absorption, whereby, when it comes into contact with water, it gets wet and it allows the passage of water therethrough. That is why full grain leather is not very suitable for the manufacturing of bags, since, in case of rain or in case of getting wet accidentally, the contents of the bag will also get wet.

When leather is provided with a protective surface treatment, such as, for example, a polyurethane varnish, it becomes waterproof, whereby the majority of leather bags have this protective surface treatment. However, that protective surface treatment causes the leather to lose its breathing capability, whereby it becomes airtight. This airtightness may cause, in case of a drop of the inside air temperature—for example, when taking the bag to a cold outdoor environment from a warm indoor environment—, the humidity contained in the inside air of the bag to condense. This may be especially serious in case of containing electronic equipment within the bag that may be damaged if condensation occurs therein.

From the above, it is recommended that the leather layer be coated with a hydrophobic agent—for example, silicone ester—to prevent the absorption of water through the holes and/or micro-holes.

Preferably, the hydrophobic additive will be applied to obtain a leather layer with an absorption lower than 10%, or a capillary absorption level lower than 1 cm/h, relative to an equivalent leather layer without the hydrophobic agent coating, said values being liable be measured, for example, by means of the guidelines of standard EN ISO 2417 in effect on the date the present application was filed.

The leather layer may also have a surface coating on its side opposite the side wherein the waterproof, breathable material layer is adhered, for example polyurethane varnish, thus increasing its waterproofness.

The leather layer may also be coated with graphene-based doping agents, which increase its tensile or abrasion resistance, and/or with an infrared-reflecting agent, to reduce its overheating when receiving direct sunlight.

It is proposed that the breathable, waterproof multi-layered material also include a reinforcing layer of non-water-absorbing, breathable material, adhered by means of hydrolysis-resistant adhesives arranged in a non-laminar fashion that allow for breathability, the layer of waterproof, breathable material remaining between the leather layer and the reinforcing layer.

It is understood that the hydrolysis-resistant adhesive is an adhesive that does not degrade in contact with water or humidity, and it will be understood that its non-laminar arrangement is an arrangement that avoids the formation of a continuous sheet of adhesive between the layers to be adhered, since said continuous sheet might prevent the breathability of the resulting material.

According to another embodiment, it is contemplated that the breathable, waterproof multi-layered material also include a 3D fabric layer of non-water-absorbing, breathable material, adhered by means of hydrolysis-resistant adhesives arranged in a non-laminar fashion that allow breathability, the layer of waterproof, breathable material remaining between the leather layer and the 3D fabric layer.

It is understood that a 3D fabric is a fabric wherein the fibres are woven following a three-dimensional pattern, obtaining in every stitch a fabric of greater thickness than the sum of the thicknesses of the fibres used in that stitch, gaps remaining on the inside of said fabric, and thereby obtaining a fabric of greater volume.

The bag may also include seams sealed by means of a waterproof adhesive tape adhered on top of said seams, thus ensuring that the seams are also waterproof.

Other features of the invention will appear in the following detailed description of an exemplary embodiment.

### BRIEF DESCRIPTION OF THE FIGURES

The foregoing and other advantages and features will be more fully understood from the following detailed description of an exemplary embodiment with reference to the attached drawings, which must be taken in an illustrative and non-limiting way, wherein:

FIG. 1 depicts a perspective view of a bag in the shape of a rucksack wherein the elements of the heating device have been indicated, with a dashed line, embedded in the interior of the bag, and its connections, according to an embodiment wherein the heating device also includes a wireless communication device configured to connect to a remote-control device in the shape of a mobile phone;

FIG. 2 depicts an exploded view of a portion of the breathable, waterproof multi-layered material proposed for its inclusion in the bag described in the present invention according to an embodiment provided with a perforated leather layer, a layer of breathable, waterproof material, and a reinforcing layer;

FIG. 3 depicts an exploded view of a portion of the breathable, waterproof multi-layered material proposed for its inclusion in the bag described in the present invention according to another embodiment provided with a perforated leather layer, a layer of breathable, waterproof material, and a reinforcing layer, which includes the heating resistor of the heating device in the shape of a winding flexible filament arranged between the waterproof, breathable layer and the reinforcing layer.

### DETAILED DESCRIPTION OF AN EXEMPLARY EMBODIMENT

The attached figures depict exemplary embodiments with a non-limiting illustrative character of the present invention.

According to a preferred exemplary embodiment of the present invention, it is proposed to create a bag, a rucksack for example, at least partially comprised of a layer 20 of breathable, waterproof multi-layered material, allowing for the breathability of said bag.

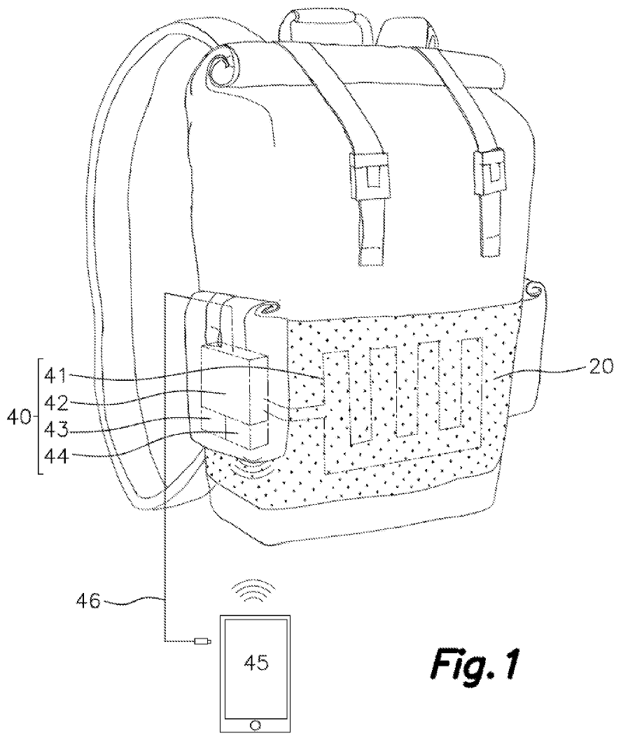

In the present exemplary embodiment depicted in FIG. 1, the proposed bag has a rolling upper closure, which ensures its water-tightness and a volume adjustable to needs.

One of the layers that make up the breathable multi-layered material 20 that forms the bag is a layer of waterproof, breathable material 21, that allows for the passage of air and vapour but prevents the passage of liquid water therethrough.

This layer of waterproof, breathable material 21 may be, for example, a layer provided with a number of pores with a size comprised between a size thousands of times smaller than the size of the water droplets and a size hundreds of times larger than the size of the water vapour molecules. In that range of sizes, the pores will allow the passage of vapour and prevent the passage of water droplets.

The present invention also proposes to include a heating device 40 comprised by at least a heating resistor 41, a battery 42, and a controller device 43.

In the present example, the heating resistor 41 is a flexible semiconductor in the shape of a cable that is arranged in a zigzagging manner attached to one of the walls that constitute the bag.

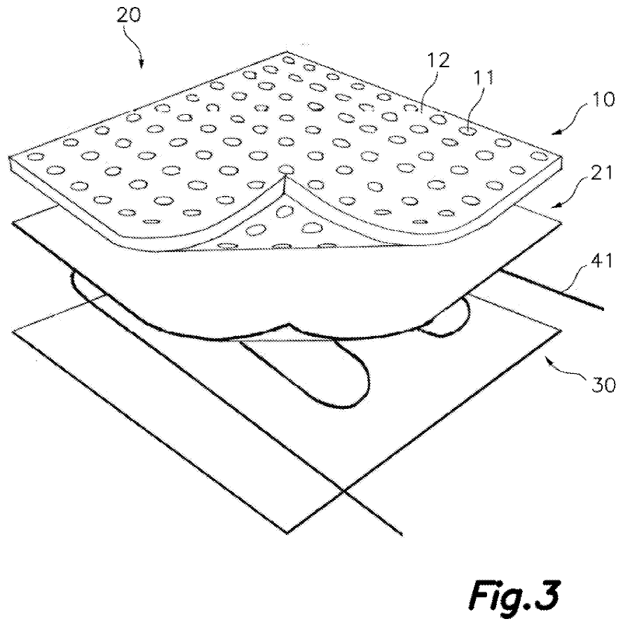

In the present example, the heating resistor 41 is attached to the breathable multi-layered material 20, whether by means of adhesives, sewing, or embedded between the different layers that constitute the breathable multi-layered material 20, as depicted in FIG. 3.

It is proposed that battery 42 be a 12V battery housed in a pocket of the bag and connected to the heating resistor 41 through a movable connector that allows for a fast connection and disconnection, making it possible to remove the battery 42 for its charging or replacement.

In the example of FIG. 1 it is shown how the battery 42 also includes an additional connection cable 46 that allows to charge a hand-held device external to the heating device 40, for example a mobile phone or another electronic device with batteries.

The controlling device 43 may be embedded in the battery 42, as shown in the example of FIG. 1, or it may be independent from the battery, then being embedded in the bag and interposed between the connection to the battery 42 and the heating resistor 41.

The controller device 43 allows to turn the power supply on or off from the battery 42 to the heating resistor 41, for example by means of a switch or according to a predefined programming.

It is contemplated, for example, that the controller device 43 may include a temperature sensor, thus allowing the controller device 43 to activate the heating resistor 41 in response to the readings obtained by the temperature sensor.

It is contemplated that the controller device 43 additionally or alternatively include a wireless communication device 44 for its connection to a remote-control device 45.

In the example of FIG. 1 the wireless communication device 44 is a WIFI or BLUETOOTH antenna, and the remote-control device 45 is a mobile phone or the like.

This allows the user to verify the state of the heating device 40, its temperature, the temperature of the bag, the battery 42 charge level, or other parameters from said remote-control device 45, as well as ordering the connection or disconnection of the heating device 40. It also allows the use of the sensors embedded in the remote-control device 45, and/or that the remote-control device 45 should access weather data through the Internet. This information received by the remote-control device 45 may be used to inform the user, or to automatically determine the turning on or off of the heating device 40.

Furthermore, said wireless communication device 44 embedded in the bag may also be used so that the user may know, through the remote-control device 45, when he/she moves away from the bag, outputting a warning signal, for example, or automatically turning off the heating device 40 when said separation of the bag relative to the remote-control device 45 occurs.

It is also contemplated that the controller device 43 may include a signal emitter selected between luminous and/or acoustic signals to inform of the activation and/or the temperature of the heating resistor 41 and/or the battery charge state. For example, one or various LEDs or a screen may be included, visible from outside of the bag, that display information of interest for the user.

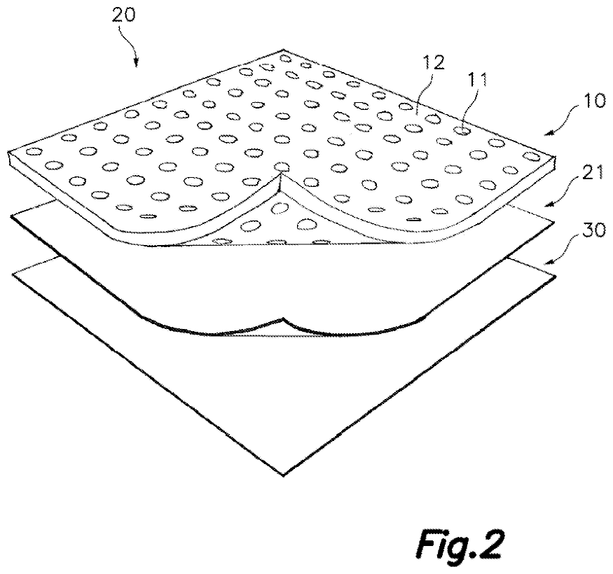

As for the composition of the breathable multi-layered material 20, it is contemplated that it may include a micro-perforated leather layer 10 with an array of micro-through holes 11 that cross it, as shown in FIGS. 2 and 3.

The leather layer 10 will preferably receive, during its curing treatment or manufacturing, a silicone ester coating to provide it with hydrophobic properties.

Optionally, a side of the leather layer 10 may receive a surface coating 12, preferably polyurethane varnish, before being micro-perforated.

It is also contemplated that the leather layer 10 be treated with a graphene-based doping agent to increase its resistance to tears and abrasion, and/or with an infrared-reflecting agent.

The resulting leather layer 10 will, therefore, be breathable thanks to the holes 11 or micro-holes 11, and it will not absorb water, thanks to the hydrophobic treatment, although it will not be waterproof, since water will be able to go through the micro-holes 11. However, the highly hydrophobic properties of the treated leather will reduce or prevent the absorption of water through said micro-holes by capillary action.

The leather of the leather layer 10 may be natural or collagenous, obtained from recycled collagen or produced by bioengineering.

The breathable, multi-layered material 20 may also include a reinforcing layer 30 that will cover the layer of waterproof, breathable material 21, protecting it. This reinforcing layer 30 may be a protection layer of non-absorbing, breathable material, or a non-absorbing, breathable 3D fabric layer.

All the layers of the breathable multi-layered material 20 are superimposed and adhered with each other by means of hydrolysis-resistant adhesives—that is, they do not degrade in contact with water or vapour—said adhesives being arranged in a non-laminar fashion—that is, they do not extend as a sheet between the layers that might act as a breathability barrier—.

It is proposed to disperse the adhesive, for instance, in the form of a spray, which deposits droplets or micro-droplets separated from each other throughout the surface to be adhered immediately before proceeding to the assembly of the layers.

An alternative embodiment may consist in dispersing an adhesive in powder form dispersed throughout the surface of one of the sides to be adhered, and subsequently superimposing the layers and cause the material to go through a grille that, by means of heat application, activates the adhesive powder particles producing the adhesion.

Another embodiment may consist in controllably depositing droplets or spaced lines of adhesive throughout the surface to be adhered.

Any of the described solutions, or others, will offer an adhesion on the whole surface, but will prevent the adhesive from acting as a barrier to the breathability of the proposed multi-layered material.

It will be understood that the different parts constituting the invention described in an embodiment may be freely combined with the parts described in other different embodiments even if said combination has not been explicitly described, as long as there is no prejudice to the combination.

What is claimed is:

1. A waterproof, breathable bag with no interior condensation that defines an interior space completely surrounded by waterproof material, at least part of said waterproof material also being a breathable multi-layered material that includes a layer of waterproof, breathable material to prevent the passage of water and to allow the passage of air therethrough;
wherein the waterproof, breathable bag includes in its interior a heating device that includes a heating resistor in thermal contact with the inside air of the bag, a battery also housed in said bag and connected to the heating resistor and a controller device.

2. (canceled)

3. (canceled)

4. The waterproof, breathable bag according to claim 1, wherein the heating resistor is attached to the waterproof material.

5. The waterproof, breathable bag according to claim 1, wherein the heating resistor is attached to the breathable, waterproof multi-layered material.

6. The waterproof, breathable bag according to claim 5, wherein the heating resistor is embedded between the layers of the breathable, waterproof multi-layered material.

7. The waterproof, breathable bag according to claim 4, wherein the heating resistor is attached by means of sewing.

8. The waterproof, breathable bag according to claim 1, wherein the controller device includes a temperature sensor and it is configured to turn the heating resistor on in response to the readings obtained by the temperature sensor.

9. The waterproof, breathable bag according to claim 1, wherein
the controller device includes a wireless communication device configured to be connected to a remote-control device; or
the controller device includes a wireless communication device configured to be connected to a remote-control device, the wireless communication device being a WIFI antenna and/or a BLUETOOTH antenna, and the remote-control device being a smart phone, smart watch, tablet, and/or computer.

10. (canceled)

11. The waterproof, breathable bag according to claim 1,
the battery is housed in a pocket of the bag;
the battery is connected to the heating resistor by means of a movable connector, allowing for the fast, simple removal and/or replacement of the battery;
wherein the battery also includes an additional connection cable configured to supply power to an additional electronic device; or
the battery also includes an additional connection cable accessible from outside of the bag, through an outer pocket configured to supply power to an additional electronic device.

12. (canceled)

13. (canceled)

14. The waterproof, breathable bag according claim 1 to, wherein the breathable, waterproof multi-layered material also includes a natural leather or collagen leather layer, this leather layer including holes and/or micro-holes to increase its breathability, the leather layer being in the extrados of the bag and the layer of waterproof, breathable material in the intrados of the bag.

15. The waterproof, breathable bag according to claim 14, wherein the leather layer is coated with a hydrophobic agent to prevent the absorption of water through the holes and/or micro-holes.

16. The waterproof, breathable bag according to claim 15, wherein the hydrophobic agent is silicone ester.

17. The waterproof, breathable bag according to claim 14, wherein
the leather layer has a surface coating on its side opposite the side wherein the layer of waterproof, breathable material is adhered; or
the leather layer has polyurethane varnish as a surface coating on its side opposite the side wherein the layer of waterproof, breathable material is adhered.

18. (canceled)

19. The waterproof, breathable bag according to claim 14, wherein the leather layer is coated with graphene-based doping agents.

20. The waterproof, breathable bag according to claim 14, wherein the breathable, waterproof multi-layered material also includes a reinforcing layer of non-water-absorbing, breathable material adhered by means of hydrolysis-resistant adhesives arranged in a non-laminar fashion allowing for breathability, the layer of waterproof, breathable material remaining between the leather layer and the reinforcing layer.

21. The waterproof, breathable bag according to claim 14, wherein a 3D fabric layer of non-water-absorbing, breathable material is also included, adhered by means of hydrolysis-resistant adhesives arranged in a non-laminar fashion allowing for breathability, the layer of waterproof, breathable material remaining between the leather layer and the 3D fabric layer.

22. The waterproof, breathable bag according to claim 1, wherein the bag includes seams sealed by means of a waterproof adhesive tape adhered on top of said seams.

23. The waterproof, breathable bag according to claim 14, wherein the leather layer is coated with an infrared-reflecting agent.

24. The waterproof, breathable bag according to claim 14, wherein:
the leather layer treated with the hydrophobic agent has an absorption equal to or smaller than 10% relative to an equivalent leather layer without a hydrophobic agent coating, and/or
the leather layer treated with the hydrophobic agent has a capillary absorption equal to or smaller than 1 cm/h relative to an equivalent leather layer without a hydrophobic agent coating, and/or
the layer of waterproof, breathable material has a water vapour permeability equal to or greater than 475 g/m²; and/or
the layer of waterproof, breathable material has a resistance to the passage of water equal to or greater than 10 psi during at least 2 minutes.

25. The waterproof, breathable bag according to claim 1, wherein the heating resistor is a flexible semiconductor.

26. The waterproof, breathable bag according to claim 1, wherein the heating device includes a signal emitter selected among luminous and/or acoustic signals to inform of the activation and/or temperature of the heating resistor and/or the battery charge state.
